(19) United States
(12) Patent Application Publication
(10) Pub. No.: US 2026/0148895 A1
(43) Pub. Date: May 28, 2026

(54) MULTILAYER ELECTRONIC COMPONENT

(71) Applicant: SAMSUNG ELECTRO-MECHANICS CO., LTD., Suwon-si (KR)

(72) Inventors: Hong Gi KIM, Suwon-si (KR); Kwan Woo SONG, Suwon-si (KR); Jun Young LEE, Suwon-si (KR); Jong Hyeon PARK, Suwon-si (KR); Jin Man KIM, Suwon-si (KR); Dong Guk LIM, Suwon-si (KR); Seung On KANG, Suwon-si (KR); Kang Hyun LEE, Suwon-si (KR)

(73) Assignee: SAMSUNG ELECTRO-MECHANICS CO., LTD., Suwon-si (KR)

(21) Appl. No.: 19/249,156

(22) Filed: Jun. 25, 2025

(30) Foreign Application Priority Data
Nov. 26, 2024 (KR) 10-2024-0170411

(51) Int. Cl. H01G 2/12; C09D 5/16; C09D 7/63; H01G 4/30

(52) U.S. Cl. CPC H01G 2/12; C09D 5/1656; C09D 7/63; H01G 4/30

(57) ABSTRACT

A multilayer electronic component includes a ceramic body including a dielectric layer and an internal electrode alternately disposed with the dielectric layer, an external electrode disposed on an exposed surface of the ceramic body at which an end portion of at least one of the internal electrodes is exposed, a first organic layer disposed to cover at least a portion of an external surface of the ceramic body, and a second organic layer disposed to cover at least a portion of an external surface of the external electrode on the exposed surface, wherein the first organic layer and the second organic layer may include different organic materials, respectively.

### CROSS-REFERENCE TO RELATED APPLICATION(S)

This application claims benefit of priority to Korean Patent Application No. 10-2024-0170411 filed on Nov. 26, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom. Such multilayer ceramic capacitors may be used as a component in various electronic devices due to having a small size, ensuring high capacitance and being easily mounted.

Recently, a method of coating a surface of a multilayer ceramic capacitor with a water repellent agent has been considered as a method for improving moisture resistance reliability of a multilayer ceramic capacitor. Silane coupling agents are mainly used as a water-repellent agent for coating the multilayer ceramic capacitors, but research into thermal and chemical stability of such water-repellent agents is needed to improve a lifespan of a water-repellent coating.

### SUMMARY

An aspect of the present disclosure is to provide a multilayer electronic component having excellent moisture resistance reliability.

However, problems to be solved by the present disclosure are not limited to the above, and will be more easily understood in the process of describing specific embodiments of the present disclosure.

A multilayer electronic component according to some embodiments of the present disclosure may comprise: a ceramic body including a dielectric layer and internal electrodes alternately disposed with the dielectric layer, an external electrode disposed on an exposed surface of the ceramic body at which an end portion of at least one of the internal electrodes is exposed, a first organic layer disposed to cover at least a portion of an external surface of the ceramic body and a second organic layer disposed to cover at least a portion of an external surface of the external electrode on the exposed surface, wherein the first organic layer and the second organic layer may include different organic materials.

A multilayer electronic component according to some embodiments of the present disclosure may comprise: a ceramic body including dielectric layer and internal electrodes alternately disposed with the dielectric layer, an external electrode disposed on the body and connected to at least one of the internal electrodes, a first organic layer disposed to cover at least a portion of an external surface of the ceramic body and a second organic layer disposed to cover at least a portion of an external surface of the external electrode, wherein the first organic layer may be a self-assembled monolayer of a first organic material, and the second organic layer may be a self-assembled monolayer of a second organic material.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 is a perspective view schematically illustrating exteriors of a ceramic body and external electrodes, with an organic layer removed from FIG. 1.

FIG. 3 schematically illustrates a cross-sectional view taken along line I-I′ of FIG. 1.

FIG. 4 schematically illustrates a cross-sectional view taken along line II-II′ of FIG. 1.

FIG. 5 schematically illustrates a cross-sectional view taken along line III-III′ of FIG. 1.

FIG. 6 is a schematic diagram illustrating a structure of a first organic layer.

FIG. 7 is a schematic diagram illustrating a structure of a second organic layer.

### DETAILED DESCRIPTION

Hereinafter, some embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness T direction, a second direction Y may be defined as a length L direction, and a third direction Z may be defined as a width W direction.

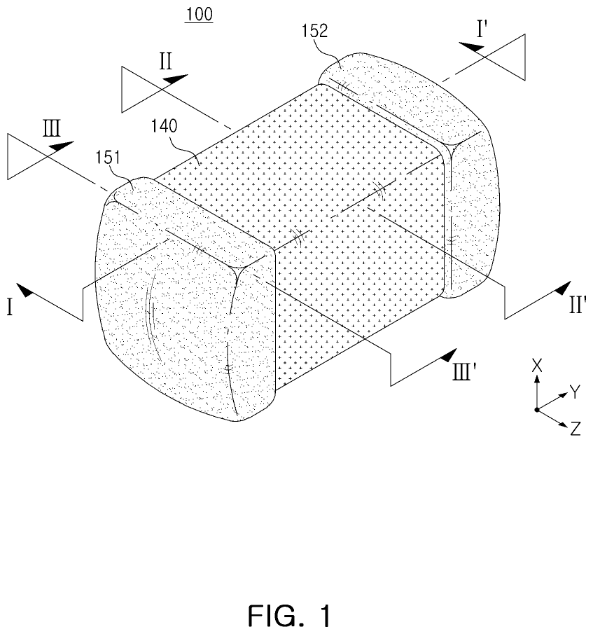

FIG. 1 is a perspective view schematically illustrating a multilayer electronic component according to an embodiment of the present disclosure.

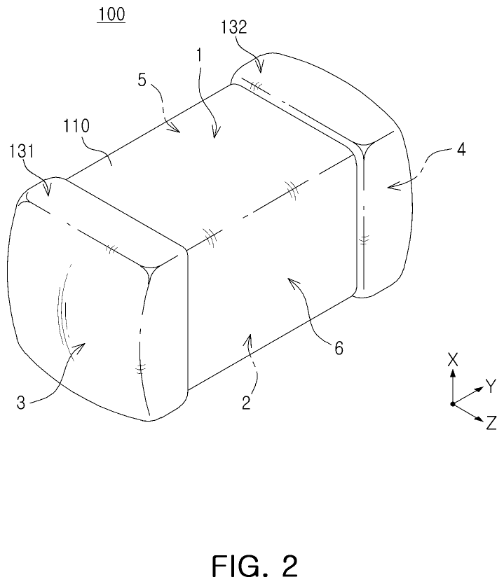

FIG. 2 is a perspective view schematically illustrating exteriors of a ceramic body and external electrodes, with an organic layer removed from FIG. 1.

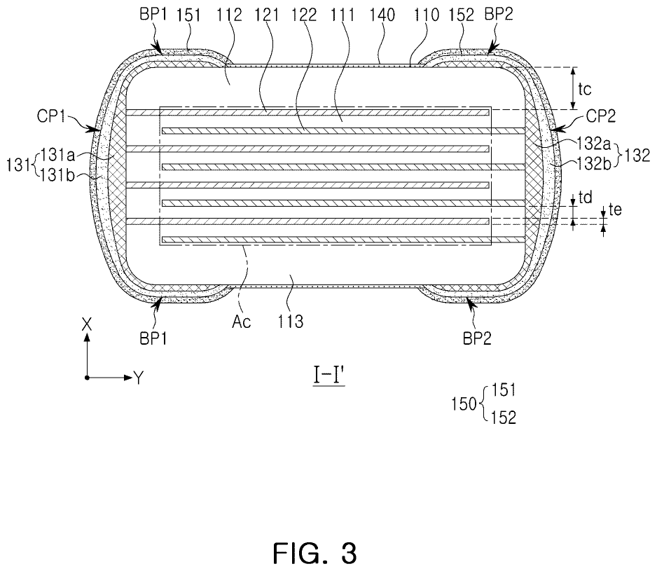

FIG. 3 schematically illustrates a cross-sectional view taken along line I-I′ of FIG. 1.

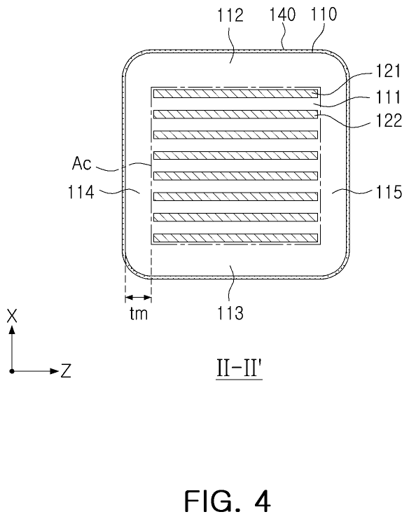

FIG. 4 schematically illustrates a cross-sectional view taken along line II-II′ of FIG. 1.

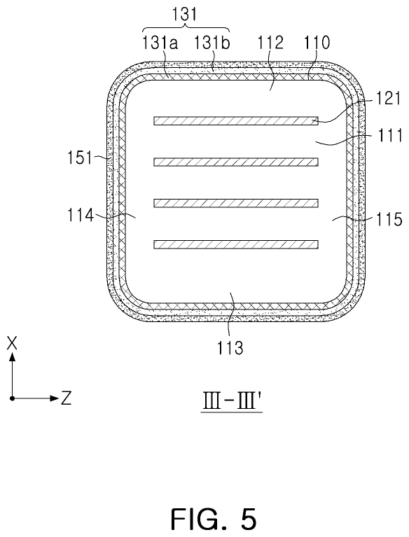

FIG. 5 schematically illustrates a cross-sectional view taken along line III-III′ of FIG. 1.

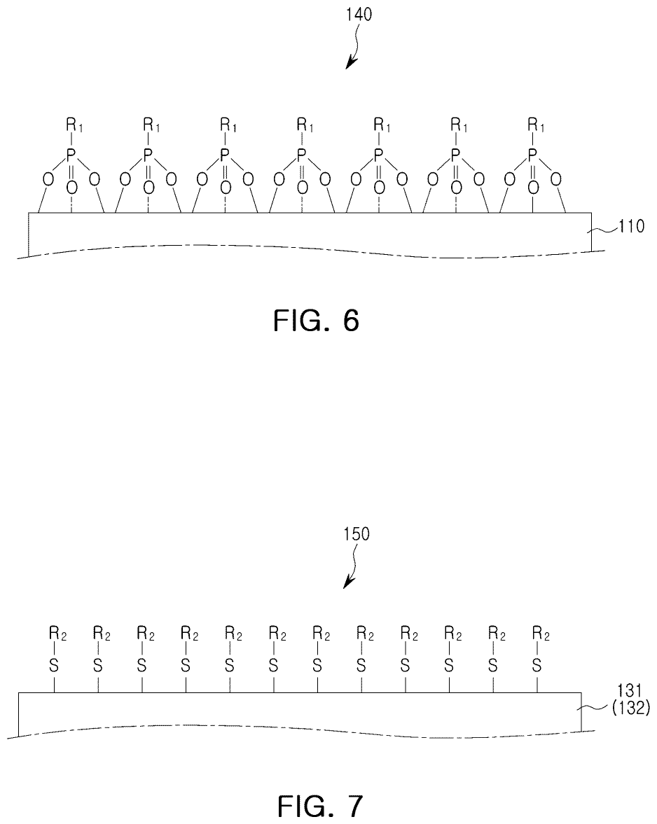

FIG. 6 is a schematic diagram illustrating a structure of a first organic layer.

FIG. 7 is a schematic diagram illustrating a structure of a second organic layer.

Hereinafter, a multilayer electronic component 100 according to an embodiment of the present disclosure will be described in detail with reference to FIGS. 1 to 7. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to some embodiments of the present disclosure may include a ceramic body 110, external electrodes 131 and 132, and a first organic layer 140, and a second organic layer 150.

There is no particular limitation on the specific shape of the ceramic body 110, but as illustrated, the ceramic body 110 may have a hexahedral shape or a shape similar thereto. Due to shrinkage of ceramic powder particles included in the ceramic body 110 during a sintering process or due to the polishing process for the corner portions of the ceramic body 110, the ceramic body 110 may not have a hexahedral shape with entirely straight lines, but may have a substantially hexahedral shape.

The ceramic body 110 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The ceramic body 110 may include a dielectric layer 111 and internal electrodes 121 and 122 disposed alternately with the dielectric layer 111 in the first direction. A plurality of dielectric layers 111 are in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃ and (Ca₁₋ₓSrₓ)(Zr_{1-y}Ti_{y})O₃ (0<x≤0.5, 0<y≤0.5).

An average thickness td of the dielectric layer 111 is not particularly limited. The average thickness td of the dielectric layer 111 may be, for example, 0.1 μm to 20 μm, 0.1 μm to 10μm, 0.1 μm to 5 μm, 0.1 μm to 2 μm, or 0.1 μm to 0.4 μm.

The internal electrodes 121 and 122 may include, for example, a first internal electrode 121 and a second internal electrode 122 that are alternately disposed in the first direction with the dielectric layer 111 interposed therebetween. The first internal electrode 121 and the second internal electrode 122, a pair of electrodes having different polarities, may be disposed opposing each other with the dielectric layer 111 therebetween. The first and second internal electrodes 121 and 122 may be electrically separated from each other by the dielectric layer 111 disposed therebetween.

The first internal electrode 121 may be spaced apart from the fourth surface 4, and an end portion of the first internal electrode 121 may be exposed to the third surface 3 and may be connected to the first external electrode 131. The second internal electrode 122 may be spaced apart from the third surface 3, and an end portion of the second internal electrode 122 may be exposed to the fourth surface 4 and may be connected to the second external electrode 132.

A conductive metal included in the internal electrodes 121 and 122 may be one or more selected from the group consisting of Ni, Cu, Pd, Ag, Au, Pt, Sn, W, Ti, and alloys thereof, and more preferably, the internal electrodes 121 and 122 may include Ni, but the present disclosure is not limited thereto.

An average thickness te of the internal electrodes 121 and 122 is not particularly limited. The average thicknesses te of the internal electrodes 121 and 122 may be, for example, 0.01 μm to 3.0 μm, 0.01 μm to 1.0 μm, or 0.01 μm to 0.4 μm.

The average thickness td of the dielectric layer 111 and the average thickness te of the internal electrodes 121 and 122 respectively refers to average thicknesses of the dielectric layer 111 and the internal electrodes 121 and 122 in the first direction. The average thickness td of the dielectric layer 111 and the average thickness te of the internal electrodes 121 and 122 may be measured by scanning a cross section of the ceramic body 110 in the first and second direction with a scanning electron microscope SEM of 10,000× magnification. More specifically, the average thickness td of the dielectric layer 111 may be measured by calculating the average after measuring the thickness at a plurality of points of one dielectric layer 111, for example, at 5 points equally spaced apart from each other in the second direction, and then taking the average value. In addition, the average thicknesses te of the internal electrodes 121 and 122 may be measured by calculating the average after measuring the thicknesses at a plurality of points of one internal electrode 121 and 122, for example, at 5 points equally spaced apart from each other in the second direction. The 5 points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thicknesses te of the internal electrodes 121 and 122 may be further generalized.

The ceramic body 110 may include capacitance formation portion Ac disposed inside the ceramic body 110 to form capacitance, and including the first and second internal electrodes 121 and 122 alternately disposed with the dielectric layer 111 therebetween, and a cover portion 112 and 113 disposed on both surfaces of the capacitance formation portion Ac opposing in the first direction. The cover portions 112 and 113 may have a similar configuration to the dielectric layer 111 except for not including internal electrodes.

An average thicknesses tc of the cover portions 112 and 113 may not be particularly limited. The average thickness tc of the cover portions 112 and 113 may be, for example, 150 μm or less, 100 μm or less, 30 μm or less, or 20 μm or less. The average thicknesses tc of the cover portions 112 and 113 may be, for example, 1 μm or more, 5 μm or more, or 10 μm or more. The average thicknesses tc of the cover portions 112 and 113 may refer to an average thickness of each of the first cover portion 112 and the second cover portion 113.

The average thickness tc of the cover portions 112 and 113 may refer to an average thickness of the cover portions 112 and 113 in the first direction, and may be an average value of thicknesses in the first direction measured at 5 points equally spaced apart from each other in a cross-section of the ceramic body 110 in the first and second directions.

The ceramic body 110 may include margin portions 114 and 115 disposed on both surfaces of the capacitance formation portion Ac opposing in the third direction. That is, the margin portions 114 and 115 may refer to a region between both ends of the internal electrodes 121 and 122 and a boundary surface of the ceramic body 110 in a cross-section of the ceramic body 110 cut in the first direction and the third direction. The margin portions 114 and 115 may have a similar configuration to the dielectric layer 111 except for not including the internal electrodes 121 and 122.

An average thicknesses tm of the margin portions 114 and 115 may not be particularly limited. The average thicknesses tm of the margin portions 114 and 115 may be, for example, 100 μm or less, 20 μm or less, or 15 μm or less. The average thicknesses tm of the margin portions 114 and 115 may be, for example, 5 μm or more or 10 μm or more. The average thicknesses tm of the margin portions 114 and 115 may refer to an average thickness of each of the first margin portion 114 and the second margin portion 115.

The average thickness tm of the margin portions 114 and 115 may refer to an average thickness of the margin portions 114 and 115 in the third direction, and may be an average value of the average thicknesses in the third direction measured at 5 points equally spaced apart from each other in a cross-section of the body 110 in the first and third directions.

The external electrodes 131 and 132 may be disposed on the exposed surface the ceramic body 110 at which an end portion of at least one of the internal electrodes 121 and 122 may be exposed. For example, the external electrodes 131 and 132 may be disposed on the third and fourth surfaces 3 and 4, and may extend onto portions of the first, second, fifth and sixth surfaces 1, 2, 5, and 6. The third and fourth surfaces 3 and 4 may be defined as a first exposure surface and a second exposure surface, respectively. The external electrodes 131 and 132 may include a first external electrode 131 disposed on the first exposed surface and connected to the first internal electrode 121, and a second external electrode 132 disposed on the second exposed surface and connected to the second internal electrode 122.

The external electrodes 131 and 132 may include connection portions CP1 and CP2 disposed on the exposed surface, and band portions BP1 and BP2 disposed to extend from the connection portions CP1 and CP2 onto both surfaces of the ceramic body 110 opposing in the first direction.

The first external electrode 131 may include a first connection portion CP1 disposed on the third surface 3, and a first band portion BP1 disposed to extend from the first connection portion CP1 onto the first and second surfaces 1 and 2. The second external electrode 132 may include a second connection portion CP2 disposed on the fourth surface 4, and a second band portion BP2 disposed to extend from the second connection portion CP2 onto the first and second surfaces 1 and 2. The band portions BP1 and BP2 may be disposed to extend from the connecting portions CP1 and CP2 to the fifth and sixth surfaces 5 and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, at least one selected from the group consisting of Cu, Ni, Pd, Pt, Au, Ag, Pb, and alloys thereof. The glass included in the base electrode layers 131a and 132a may include, for example, one or more selected from the group consisting of oxides of Ba, Ca, Zn, Al, B, and Si.

Meanwhile, the base electrode layers 131a and 132a may be configured by only the sintered electrode layer, but the present disclosure may not be limited thereto, and the base electrode layers 131a and 132a may include, a sintered electrode layer including metal and glass, and a resin electrode layer disposed on the sintered electrode layer and including metal particles and resin.

The metal particles included in the resin electrode layer may include at least one of spherical particles or flake-shaped particles. The metal included in the resin electrode layer may include, for example, at least one selected from the group consisting of Cu, Ni, Pd, Pt, Au, Ag, Pb, Sn and alloys thereof. The resin included in the resin electrode layer may include, for example, one or more of epoxy resin, acrylic resin, and ethyl cellulose.

The plating layers 131b and 132b may include, for example, at least one selected from the group consisting of Ni, Sn, Pd and alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

The multilayer electronic component 100 may include a first organic layer 140 disposed to cover at least a portion of an external surface of a ceramic body 110. The first organic layer 140 may be disposed on, for example, at least one of the first, second, fifth and sixth surfaces 1, 2, 5, and 6. The first organic layer 140 may be sequentially disposed on, for example, the first, second, fifth and sixth surfaces 1, 2, 5, and 6.

In some embodiments, the first organic layer 140 may be disposed so as to contact the external surface of the ceramic body 110. The first organic layer 140 may be disposed to contact at least one of, for example, the first, second, fifth, and sixth surfaces 1, 2, 5, or 6. The first organic layer 140 may be disposed to contact, for example, the first, second, fifth, and sixth surfaces 1, 2, 5, and 6, respectively.

The multilayer electronic component 100 may include a second organic layer 150 disposed to cover at least a portion of an external surface of the external electrodes 131 and 132 on the exposed surface. The second organic layer 150 may include, for example, a first coating film 151 disposed to cover at least a portion of an external surface of the first external electrode 131 on the third surface 3 and a second coating film 152 disposed to cover at least a portion of an external surface of the second external electrode 132 on the fourth surface 4.

In some embodiments, the second organic layer 150 may be disposed so as to contact the external surface of the external electrode 131 and 132. For example, the first coating film 151 may be disposed to contact the external surface of the first external electrode 131, and the second coating film 152 may be disposed to contact the external surface of the second external electrode 132.

According to some embodiments of the present disclosure, the first organic layer 140 and the second organic layer 150 may include different organic materials. The ceramic body 110 and the external electrodes 131 and 132 may have different main components configuring their surfaces. For example, the main component configuring the external surface of the ceramic body 110 may be ceramic, and the main component configuring the external surface of the external electrode 131 and 132 may include a metal. A type of organic material included in the first organic layer 140 and the second organic layer 150 may need to be determined by appropriately considering the main component of the external surface on which the first organic layer 140 and the second organic layer 150 may be disposed, for thermal stability and chemical stability of the first organic layer 140 and the second organic layer 150. Since the first organic layer 140 and the second organic layer 150 may contain different organic materials, the organic material suitable for the first organic layer 140 and the organic material suitable for the second organic layer 150 may be considered and determined, respectively.

For example, a first organic material having excellent bonding force with ceramic may be added to the first organic layer 140 disposed to cover the external surface of the ceramic body 110. That is, the first organic material included in the first organic layer 140 may have greater bonding force with ceramic than with metal. For example, a second organic material having excellent bonding force with metal may be added to the second organic layer 150 disposed to cover the external surface of the external electrode 131 and 132. That is, the second organic material included in the second organic layer 150 may have greater bonding force with metal than with ceramic. In some embodiments, the bonding force may be measured experimentally or theoretically using methods such as Temperature Programmed Desorption (TPD), X-ray Photoelectron Spectroscopy (XPS), and Density Functional Theory (DFT).

In some embodiments, the first organic layer 140 may include a phosphoric acid compound. In the present disclosure, the term “phosphoric acid compound” may refer to a compound having at least one phosphate group in its molecular structure. The phosphoric acid compound may have greater bonding force with ceramic than with metal. This may improve thermal stability and chemical stability of the first organic layer 140 disposed to cover the external surface of the ceramic body 110.

In another embodiments, the second organic layer 150 may include a thiol compound. In the present disclosure, the term “thiol compound” may refer to a compound having at least one thiol group in its molecular structure. The thiol compound may have a greater bonding force with metal than with ceramic. This may improve the thermal stability and chemical stability of the second organic layer 150 disposed to cover the external surface of the external electrode 131 and 132.

In another embodiments, at least one of the first organic layer 140 or the second organic layer 150 may be a self-assembled monolayer. For example, the first organic layer 140 may be the self-assembled monolayer of a first organic material, and the second organic layer 150 may be the self-assembled monolayer of a second organic material.

The self-assembled monolayer may refer to an organic monolayer spontaneously aligned and formed on the surface of the ceramic body 110 or the external electrodes 131 and 132.

The self-assembled monolayer may include, for example, a head group that chemically bonds to the surface of the ceramic body 110 or the external electrodes 131 and 132, a linker group connected to the head group, and a functional group connected to an end of the linker group.

For example, the first organic layer 140 may be a phosphate-based self-assembled monolayer containing a phosphate group as the head group. That is, the first organic material may include a phosphate group. The second organic layer 150 may be a thiol-based self-assembled monolayer containing a thiol group as the head group. That is, the second organic material may include the thiol group.

For example, the phosphate group of the phosphoric acid compound included in the first organic layer 140 may chemically bond with the external surface of the ceramic body 110, and the thiol group of the thiol compound included in the second organic layer 150 may chemically bond with the external surface of the external electrodes 131 and 132. A chemical bond between the phosphoric acid compound and the ceramic body 110, and a chemical bond between the thiol compound and the external electrodes 131 and 132 may be, for example, a covalent bond. That is, the first organic layer 140 may be chemically adsorbed on the surface of the ceramic body 110, and the second organic layer 150 may be chemically adsorbed on the surface of the external electrodes 131 and 132.

The linker group of the self-assembled monolayer may include an aliphatic compound and/or an aromatic compound to provide hydrophobic characteristics to the first and second organic layers 140 and 150. The linker group may be, for example, an alkyl group having five or more carbon atoms and/or a phenyl group. That is, as illustrated in FIG. 6, the phosphoric acid compound included in the first organic layer 140 may include at least one of the alkyl group having five or more carbon atoms and a phenyl group as a linker group R1. In addition, as illustrated in FIG. 7, the thiol compound included in the second organic layer 150 may include at least one of the alkyl group having five or more carbon atoms and a phenyl group as a linker group R2. In some embodiments, the linker group may include such as —(CH₂)₅—, —(CH₂)₆—, —(CH₂)₈—, or —C₆H₅.

The functional group of the self-assembled monolayer may be a hydrophobic functional group to improve a moisture resistance reliability of the multilayer electronic component 100, and is not particularly limited. For example, the hydrophobic functional group may include a methoxy group, a benzene group, and/or 2PACz.

The phosphoric acid compound may include, for example, an alkanephosphonic acid, and the thiol compound may be, for example, an alkanethiol.

Meanwhile, a presence, type, and characteristics of organic materials included in the first and second organic layers 140 and 150 may be measured using an infrared absorption spectrum, an ultraviolet/visible absorption spectrum, an MS spectrum, a ¹H NMR spectrum, an elemental analysis, or the like, but are not limited thereto, and may be measured using a general analysis method widely used in the art.

The first organic layer 140 may be disposed to cover only a portion of the external surface of the ceramic body 110. However, to more effectively improve the moisture resistance reliability of the multilayer electronic component 100, the first organic layer 140 may be disposed to completely cover a region of the external surface of the ceramic body 110 that is not covered by the external electrodes 131 and 132. In this case, the region of the external surface of the ceramic body 110 that is not covered by the external electrodes 131 and 132 may refer to, for example, a region of the ceramic body 110 exposed to the outside between the first band portion BP1 and the second band portion BP2.

Additionally, the second organic layer 150 may be disposed to cover only a portion of the external surface of the external electrodes 131 and 132. However, to more effectively improve the moisture resistance reliability of the multilayer electronic component 100, the second organic layer 150 may be disposed to cover at least a portion of the connection portions CP1 and CP2 and at least a portion of the band portions BP1 and BP2. That is, the first coating film 151 may be disposed to cover at least a portion of the first connection portion CP1 and at least a portion of the first band portion BP1, and the second coating film 152 may be disposed to cover at least a portion of the second connection portion CP2 and at least a portion of the second band portion BP2.

More preferably, the second organic layer 150 may be disposed to completely cover the connection portions CP1 and CP2 and the band portions BP1 and BP2. That is, the first coating film 151 may be disposed to completely cover the first connection portion CP1 and the first band portion BP1, and the second coating film 152 may be disposed to completely cover the second connection portion CP2 and the second band portion BP2.

Meanwhile, the bonding force of the first organic layer 140 with the external electrodes 131 and 132 may be lower than the bonding force of the first organic layer 140 with the ceramic body 110. That is, the first organic layer 140 formed on the external electrodes 131 and 132 may have relatively low thermal and chemical stability. Therefore, it may be preferable that the first organic layer 140 not be disposed on the connection portions CP1 and CP2. Additionally, the first organic layer 140 may partially contact with the ends portion of the band portions BP1 and BP2, but may not completely cover the band portions BP1 and BP2. For example, the band portions BP1 and BP2 may include a round-shaped end region and a generally flat extended region disposed between the connection portions CP1 and CP2 and the end region, and the first organic layer 140 may be disposed to cover a portion of the end region, but may not be disposed on the extended region.

In addition, the bonding force of the second organic layer 150 with the ceramic body 110 may be lower than the bonding force of the second organic layer 150 with the external electrodes 131 and 132. That is, the second organic layer 150 formed on the ceramic body 110 may have relatively low thermal and chemical stability. Therefore, it may be preferable for the second organic layer 150 not to be in direct contact with the ceramic body 110. The second organic layer 150 may be disposed to cover an end portion of the first organic layer 140, but may not completely cover the first organic layer 140.

Hereinafter, an example of a method for manufacturing a multilayer electronic component 100 will be described. An example of a method for forming a ceramic body 110 will be described. However, the manufacturing method of the multilayer electronic component 100 is not limited thereto.

First of all, ceramic powder for forming a dielectric layer 111 are prepared. The ceramic powder may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol, a binder such as polyvinyl butyral, or the like are mixed to prepare a ceramic slurry, and then the ceramic slurry is applied and dried on a carrier film to prepare a ceramic green sheet.

Next, conductive paste for an internal electrode containing metal powder, binder, organic solvent, or the like may be printed onto the ceramic green sheet with a predetermined thickness using a screen printing method or a gravure printing method, thereby forming an internal electrode pattern.

Thereafter, the ceramic green sheet having the internal electrode pattern printed thereon may be peeled off from the carrier film, and then the ceramic green sheet having the internal electrode pattern printed in a predetermined amount of layers are laminated and pressed to form ceramic laminate. On the upper and lower portions of the ceramic laminate, a ceramic green sheet forming a cover portion without an internal electrode pattern, may be laminated in a predetermined amount of layers to form the cover portion 112 and 113 after sintering. Thereafter, the ceramic laminate is cut to have a predetermined size of a chip, and the cut chip may be sintered at a temperature of 1000° C. or higher and 1400° C. or lower to form the body 110.

Meanwhile, the margin portions 114 and 115 may be formed by applying and sintering the conductive paste for an internal electrodes on the ceramic green sheet except for a location where the margin portions are to be formed. Alternatively, in order to suppress a step difference by the internal electrodes 121 and 122, the ceramic laminate may be cut so that the internal electrode pattern is exposed on both surfaces of the cut chip in the third direction, and then a sheet for forming the margin portion may be attached on both surfaces of the cut chip in the third direction and then sintered to form the margin portions 114 and 115.

Next, the external electrodes 131 and 132 may be formed. For example, when the base electrode layers 131a and 132a include a sintered electrode layer, the ceramic body 110 may be dipped in the external electrode conductive paste including metal powder, glass frit, binder, and an organic solvent, and then the external electrode conductive paste may be sintered at a temperature of 500° C. to 900° C. to form a sintered electrode layer.

For example, when the base electrode layers 131a and 132a include a resin electrode layer, the body may be dipped in a conductive resin composition including metal powder, resin, binder, and organic solvent, followed by curing heat treatment at a temperature of 250° C. to 550° C. to form the resin electrode layer.

In addition, an electrolytic plating method and/or an electroless plating method may be additionally performed to form plating layers 131b and 132b on the base electrode layers 131a and 132a.

Next, organic layers 140 and 150 may be formed. For example, a first organic material, which may be a phosphoric acid compound having a phosphate group, may be coated on the ceramic body 110 on which external electrodes 131 and 132 are formed by using a liquid phase deposition method or a vapor phase deposition method. Therefore, a first organic layer 140 in a form of a self-assembled monolayer may be formed by chemical adsorption of a phosphate group onto the ceramic body 110.

Meanwhile, the first organic material may also be partially applied onto the external electrodes 131 and 132, but since the bonding force between the first organic material and the external electrodes 131 and 132 is weak, the first organic material applied onto the external electrodes 131 and 132 may be removed through a process such as washing, or the like.

Next, the second organic material, the thiol compound having a thiol group, may be coated on the external electrodes 131 and 132 by using a liquid phase method or a gas phase method. Therefore, the thiol group may be chemically adsorbed to the external electrodes 131 and 132 to form second organic layer 150 in the form of a self-assembled monolayer.

Meanwhile, the second organic material may be partially applied on the first organic layer 140, but since the bonding force between the second organic material and the first organic layer 140 is weak, the second organic material applied on the first organic layer 140 may be removed through a process such as washing or naturally.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression “an example embodiment” does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. In addition, the terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent moisture resistance reliability can be provided.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a ceramic body including a dielectric layer and internal electrodes alternately disposed with the dielectric layer;
an external electrode disposed to cover at least a portion of an external surface of the ceramic body at which an end portion of at least one of the internal electrodes is exposed;
a first organic layer disposed to cover at least a portion of an external surface of the ceramic body on which the external electrode is not disposed; and
a second organic layer disposed to cover at least a portion of an external surface of the external electrode on the exposed surface;
wherein the first organic layer and the second organic layer including different organic materials.

2. The multilayer electronic component of claim 1, wherein the first organic layer includes a phosphoric acid compound.

3. The multilayer electronic component of claim 1, wherein the second organic layer includes a thiol compound.

4. The multilayer electronic component of claim 2, wherein the second organic layer includes a thiol compound.

5. The multilayer electronic component of claim 1, wherein at least one of the first and second organic layers is a self-assembled monolayer.

6. The multilayer electronic component of claim 4, wherein a phosphate group of the phosphoric acid compound chemically bonds with the external surface of a ceramic body,
wherein a thiol group of the thiol compound chemically bonds with the external surface of an external electrode.

7. The multilayer electronic component of claim 4,
wherein each of the phosphoric acid compound and the thiol compound has one or more selected from the group consisting of: an alkyl group having five or more carbon atoms; and a phenyl group.

8. The multilayer electronic component of claim 1, wherein an organic material contained in the first organic layer has a greater bonding force with ceramic than with a metal,
wherein an organic material contained in the second organic layer has a greater bonding force with metal than with ceramic.

9. The multilayer electronic component of claim 1, wherein the first organic layer is disposed to contact with the external surface of the ceramic body, and
wherein the second organic layer is disposed to contact with the external surface of the external electrode.

10. The multilayer electronic component of claim 1, wherein the first organic layer is disposed to completely cover a region of the external surface of the ceramic body not covered by the external electrode.

11. The multilayer electronic component of claim 1, wherein the dielectric layer and the internal electrodes are alternately disposed in a first direction,
wherein the external electrode includes a connection portion disposed on the exposed surface, and a band portion extended from the connection portion onto both surfaces of the ceramic body opposing each other in the first direction,
wherein the second organic layer is disposed to cover at least a portion of the connection portion and at least a portion of the band portion.

12. The multilayer electronic component of claim 11, wherein the second organic layer is disposed to completely cover the connection portion and the band portion.

13. A multilayer electronic component comprising:
a ceramic body including a dielectric layer and internal electrodes alternately disposed with the dielectric layer;
an external electrode disposed to cover at least a portion of an external surface of the ceramic body and connected to at least one of the internal electrodes;
a first organic layer disposed to cover at least a portion of an external surface of the ceramic body on which the external electrode is not disposed; and
a second organic layer disposed to cover at least a portion of an external surface of the external electrode;
wherein the first organic layer is a self-assembled monolayer of a first organic material, and the second organic layer is a self-assembled monolayer of a second organic material.

14. The multilayer electronic component of claim 13, wherein the first organic material includes a phosphate group.

15. The multilayer electronic component of claim 13, wherein the second organic material includes a thiol group.

16. The multilayer electronic component of claim 1, wherein the first organic layer disposed the portion of the external surface of the ceramic body on which the external electrode is not disposed.
